(19) United States
(12) Patent Application Publication
(10) Pub. No.: US 2008/0225946 A1
(43) Pub. Date: Sep. 18, 2008

(54) Error Concealment Technique Using Weighted Prediction

(76) Inventors: Peng Yin, Plainsboro, NJ (US); Cristina Gomila, Princeton, NJ (US); Jill Macdonald Boyce, Manalapan, NJ (US)

Correspondence Address: Joseph J. Laks;Thomson Licensing LLC, 2 Independence Way, Patent Operations, PO Box 5312, PRINCETON, NJ, 08543, US

(21) Appl. No.: 10/589,640

(22) PCT Filed: Feb. 27, 2004
(86) PCT No.: PCT/US04/06205

§ 371 Date: Aug. 14, 2006

(51) Int. Cl. H04N 7/32

(52) U.S. Cl. 375/240.12; 375/E07.246

(57) ABSTRACT

A decoder (10) conceals errors in a coded image comprised of a stream of macroblocks by examining each macroblock for pixel errors. If such errors exist, then each of at least two macroblocks pictures from each of two different pictures are weighted to yield a weighted prediction (WP) for estimating missing/corrupt values to conceal the macroblock found to have pixel errors.

### TECHNICAL EIELD

This invention relates to a technique for concealing errors in a coded image formed of an array of macroblocks.

### BACKGROUND ART

In many instances, video streams undergo compression (coding) to facilitate storage and transmission. Presently, there exist a variety of coding schemes, including block-based coding schemes such as the proposed ISO/ITU H.2.64 coding technique. Not infrequently, such coded video streams incur data losses or become corrupted during transmission because of channel errors and/or network congestion. Upon decoding, the loss/corruption of data manifests itself as missing/corrupted pixel values that give rise to image artifacts. To reduce such artifacts, a decoder will “conceal” such missing/corrupted pixel values by estimating the values from other macroblocks of the same picture image or from other pictures. The phrase error concealment is a somewhat of a misnomer because the decoder does not actually hide missing/corrupted pixel values.

Spatial concealment seeks to derive (estimate) the missing/corrupted pixel values from pixel values from other areas in the same image relying on the similarity between neighboring regions in the spatial domain. Temporal concealment seeks to derive the missing/corrupted pixel values from other images having temporal redundancy. In general, the error-concealed image will approximate the original image. However, using an error-concealed image as reference will propagate errors. When a sequence or group of pictures involves fades or dissolves, the current picture enjoys a stronger correlation to the reference picture scaled by a weighting factor than to the reference picture itself. In such a case, the commonly used temporal concealment technique that relies only on motion compensation will produce poor results.

Thus, a need exists for a concealment technique that advantageously affords reduced error propagation.

### BRIEF SUMMARY OF THE INVENTION

Briefly, in accordance with a preferred embodiment of the present principles, there is provided a technique for concealing errors in a coded image comprised of a stream of macroblocks. The method commences by examining each macroblock for pixel errors. If such an error exists, then at least one macroblock from at least one picture is weighted to yield a weighted prediction (WP) for estimating missing/corrupt values to conceal the macroblock found to have pixel errors.

### BRIEF SUMMARY OF THE DRAWINGS

FIG. 1 depicts a block schematic diagram of a video decoder for accomplishing WP;

FIG. 2 depicts the steps of a method performed in accordance with present principles for concealing errors using WP;

FIG. 3A depicts the steps associated with a priori selection of a WP mode for error concealment;

FIG. 3B depicts the steps associated with a posteriori selection of the WP mode for error concealment;

FIG. 4 graphically depicts the process of curve fitting to find the average of the missing pixel data; and

FIG. 5 depicts curve fitting for macroblocks experiencing linear fading/dissolving.

### DETAILED DESCRIPTION

Introduction

To fully appreciate the method of the present principles for concealing errors in an image comprised of a stream of coded macroblocks by weighted prediction, a brief description of the JVT standard for video compression will prove helpful. The JVT standard (also known as H.264 and MPEG AVC) comprises the first video compression standard to adopt Weighted Prediction (WP). With video compression techniques prior to JVT, such as the video compression techniques prescribed by MPEG-1, 2 and 4, the use of single reference picture for prediction (i.e., a “P” picture) did not give rising to scaling. When bidirectional prediction is used (“B” pictures), predictions are formed from two different pictures, and then the two predictions are averaged together, using equal weighting factors of (½, ½), to form a single averaged prediction. The JVT standard permits the use of multiple reference pictures for inter-prediction, with a reference picture index coded to indicate the use of a particular one of the reference pictures. With pictures (or P slices), only single directional prediction is used, and the allowable reference pictures are managed in a first list (list 0). With B pictures (or B slices), two lists of reference pictures are managed, list 0 and list 1. For such B pictures (or B slices), the JVT standard allows single directional prediction using either list 0 or list 1 as well as Bi-prediction using both list 0 and list 1. When using bi-prediction, an average of the list 0 and the list 1 predictors forms a final predictor. A parameter nal_ref_idc indicates the use of B picture as a reference picture in the decoder buffer. For convenience, the term B_stored refers to a B picture used as a reference picture, whereas the term B_disposable refers to a B picture not used as a reference picture. The JVT WP tool allows arbitrary multiplicative weighting factors and additive offsets for application to reference picture predictions in both P and B pictures.

The WP tool affords a particular advantage for coding fading/dissolve sequences. When applied to a single prediction, as in a P picture, WP achieves results similar to leaky prediction, which has been previously proposed for error resiliency. Leaky prediction becomes a special case of WP, with the scaling factor limited to the range 0≦α≦1. JVT WP allows negative scaling factors, and scaling factors greater than one.

The Main and Extended profiles of the JVT standard support Weighted Prediction (WP). The sequence parameter set for P and SP slices indicates the use of WP. There exist two WP modes: (a) the explicit mode, which supports P, SP, and B slices, and (b) the implicit mode that supports B slices only. A discussion of the explicit and implicit modes appears below.

Explicit Mode

In explicit mode, the WP parameters are coded in the slice header. A multiplicative weighting factor and additive offset for each color component can be coded for each of the allowable reference pictures in list 0 for P slices and B slices. All slices in the same picture must use the same WP parameters, but they are retransmitted in each slice for error resiliency. However, different macroblocks in the same picture can use different weighting factors even when predicted from the same reference picture store. This can be made possible by using memory management control operation (MMCO) commands to associate more than one reference picture index with a particular reference picture store.

Bi-prediction uses a combination of the same weighting parameters as used for single prediction. The final inter prediction is formed for the pixels of each macroblock or macroblock partition, based on the prediction type used. For single directional prediction from list 0, the weighted predictor, SampleP, is given-by Equation (1)

SampleP=Clip1(((SampleP0·W₀+2^{LWD-1})>>LWD)+O₀) (1)

and for single directional prediction from list 1, the value of SampleP is given by:

SampleP=Clip1(((SampleP1·W₁+2^{LWD-1})>>LWD)+O₁) (2)

and for bi-prediction,

SampleP=Clip1(((SampleP0·W₀+SampleP1·W₁+2^{LWD})

>>(LWD+1))+(O₀+O₁+1)>>1) (3)

where Clip1( ) is an operator that clips to the range [0, 255], W₀ and O₀ are the list 0 reference picture weighting factor and offset, respectively, and W₁ and O₁ are the list 1 reference picture weighting factor and offset, respectively, and LWD is the log weight denominator rounding factor. SampleP0 and SampleP1 are the list 0 and list 1 initial predictors, and SampleP is the weighted predictor.

Implicit Mode

In the WP implicit mode, weighting factors are not explicitly transmitted in the slice header, but instead are derived based on the relative distances between the current picture and the reference pictures. The Implicit mode is used only for bi-predictively coded macroblocks and macroblock partitions in B slices, including those using direct mode. The same formula for bi-prediction as given in the preceding explicit mode section for bi-prediction is used, except that the offset values O₀ and O₁ are equal to zero, and the weighting factors W₀ and W₁ are derived using the formulas below.

X=(16384+(TD_{D}>>1))/TD_{D}

Z=clip3(−1024, 1023,(TD_{B}·X+32)>>6)

W₁=Z>>2 W₀=64 −W₁ (4)

This is a division-free, 16-bit safe operation implementation of

W₁=(64*TD_{D})/TD_{B}

where TD_{B} is temporal difference between the list 1 reference picture and the list 0 reference picture, clipped to the range [−128, 127] and TD_{B} is difference of the current picture and the list 0 reference picture, clipped to the range [−128, 127].

Heretofore, no WP tool existed for error concealment purposes. While WP (leaky prediction) has found application for error resiliency, it is not designed to handle the use of multiple reference frames. In accordance with the present principles, there is provided a method for using Weighted Prediction (WP) for error concealment purposes, which can be implemented in any video decoder compliant with compression standards, such as the JVT standard, which can implement WP, with no extra cost.

Description of JVT-Compliant Decoder for WP Concealment

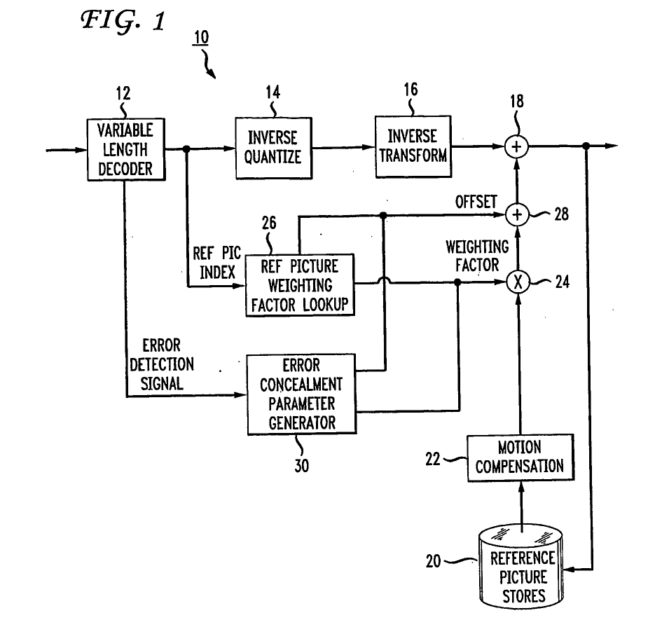

FIG. 1 depicts a block schematic diagram of a JVT-compliant video decoder 10 for accomplishing WP to enable Weighted Prediction error concealment in accordance with the present principles. The decoder 10 includes a variable length decoder block 12 that performs entropy decoding on an incoming coded video stream coded in accordance with the JVT standard. The entropy-decoded video stream output by the decoder block 12 undergoes inverse quantization at block 14, and then undergoes inverse transformation at block 16 prior to receipt at a first input of a summer 18.

The decoder 10 of FIG. 1 includes a reference picture store (memory) 20, which stores successive pictures produced at the decoder output (i.e., the output of the summer 18) for use in predicting subsequent pictures. A Reference Picture Index value serves to identify the individual reference pictures stored in the reference picture store 20. A motion compensation block 22 motion-compensates the reference picture(s) retrieved from the reference picture store 20 for inter-prediction. A multiplier 24 scales the motion-compensated reference picture(s) by a weighting factor from a Reference Picture Weighting Factor Look-up Table 26. Within the decoded video stream produced by the variable length decoder block 12 is a Reference Picture Index that identifies the reference picture(s) used for inter-prediction of macroblocks within the image. The Reference Picture Index serves as the key to looking up the appropriate weighting factor and offset value from the Table 26. The weighted reference picture data produced by the multiplier 24 undergoes summing at a summer 28 with the offset value from the Reference Picture Weighting Look-up Table 26. The combined reference picture and offset value summed at the summer 28 serves as the second input to the summer 18 whose output serves as the output of the decoder 10.

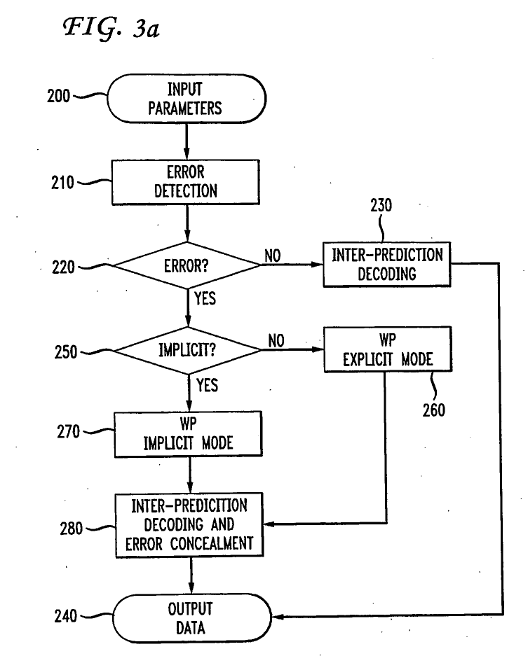

In accordance with the present principles, the decoder 10 not only performs Weighted Prediction for the purpose of forecasting successive decoded macroblocks, but also accomplishes error concealment using WP. To that end, the variable length decoder block 12 not only serves to decode incoming coded macroblocks but also to examine each macroblock for pixel errors. The variable length decoder block 12 generates an error detection signal in accordance with the detected pixel errors for receipt by an error concealment parameter generator 30. As discussed in detail with respect to FIGS. 3A and 3B, the generator 30 generates both a weighting factor and an offset value for receipt by the summers 24 and 28, respectively, to conceal pixel errors.

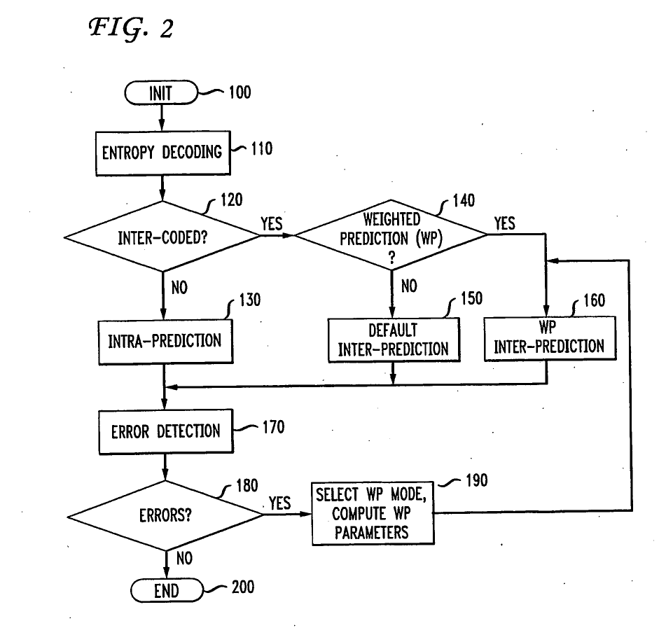

FIG. 2 illustrates the steps of the method of the present principles for concealing errors using weighted prediction in a JVT (H.264) decoder, such as decoder 10 of FIG. 1. The method commences upon initialization (step 100) during which the decoder 10 is reset. Following step 100, each incoming macroblock received at the decoder 10 undergoes entropy decoding at the variable length decoder block 12 of FIG. 1 during step 110 of FIG. 2. A determination is then made during step 120 of FIG. 2 whether the decoded macroblock was originally inter-coded (i.e., coded by reference to another picture). If not, then execution of step 130 occurs, and the decoded macroblock undergoes intra-prediction, i.e., prediction using one or more macroblocks from the same picture.

For inter-coded macroblocks, execution of step 140 follows step 120. During step 140, a check occurs whether the inter-coded macroblock was coded using weighted prediction. If not, then the macroblock undergoes default inter-prediction (i.e., the macroblock undergoes inter-prediction using default values) during step 150. Otherwise, the macroblock undergoes WP inter-prediction during step 160. Following execution of steps 130, 150 or 160, error detection (as performed by the variable length decoder block 12 of FIG. 1) occurs during step 170 to determine the presence of missing or corrupted pixel errors. Should errors exist, then step 190 occurs and the appropriate WP mode (implicit or explicit) is selected, and the generator 30 of FIG. 1 selects the corresponding WP parameters. Thereafter, program execution branches to step 160. Otherwise, in the absence of any errors, the process ends (step 200).

As discussed previously, the JVT video decoding standard prescribes two WP modes: (a) the explicit mode supported in P, SP, and B slices, (b) and the implicit mode supported in B slices only. The decoder 10 of FIG. 1 selects the explicit or implicit mode in accordance with one of several methods for mode selection process described hereinafter. The WP parameters (weighting factors and offsets) are then established, in accordance with selected the WP mode (implicit or explicit). The reference pictures can be from any of the previously decoded pictures included in list 0 or list 1, however, the latest stored decoded pictures should serve as reference pictures for concealment purposes.

WP mode selection

Based on whether or not WP was used in encoded bit stream for the current and/or reference pictures, different criteria can be used to decide which WP mode is used in error concealment. If WP is used on the current picture or neighboring pictures, WP will also be used for error concealment. WP must be applied to all or none of the slices in a picture, so the decoder 10 of FIG. 1 can determine, whether WP is used in the current picture by examining other slices of the same picture that were received without transmission error, if any. WP for error concealment for in accordance with the present principles, can be done using the implicit mode, the explicit mode, or both modes.

FIG. 3A depicts the steps of the method employed to select one of the implicit and explicit WP modes a priori, that is, in advance of accomplishing error concealment. The mode selection of FIG. 3A method commences upon the input of all of the requisite parameters during step 200. Thereafter, error detection occurs during step 210 to establish whether an error exists in the current picture/slice. Next, a check occurs during step 220 whether any errors were found during step 210. If no errors were found, no error concealment is required and inter-prediction decoding occurs during step 230, followed by output of the data during step 240.

Upon finding an error during step 220, a check is then made during step 250 whether the implicit mode was indicated in the picture parameter set used in the coding of the current picture, or in any previously coded pictures. If not, then step 260 occurs and the WP explicit mode is selected and the generator 30 of FIG. 1 establishes the WP parameters (weighting factors and offsets) for this mode. Otherwise, when the implicit mode was selected, then WP parameters (weighting factors and offsets) are obtained based on relative distances between the current picture and the reference pictures during step 270. Following either of steps 260 or 270, inter-prediction mode decoding and error concealment occurs during step 280 prior to data output during step 240.

FIG. 3B depicts the steps of the method employed to select one of the implicit and explicit WP modes a posteriori using the best results obtained after performing both inter-prediction decoding and error concealment. The mode selection of FIG. 3B method commences upon the input of all of the requisite parameters during step 300. Thereafter, error detection occurs during step 310 to establish whether an error exists in the current macroblock. Next, a check occurs during step 320 whether any errors were found during step 310. If no errors were found, no error concealment is required and inter-prediction decoding occurs during step 330, followed by output of the data during step 340.

Upon finding an error during step 320, steps 340 and 350 both occur during which the decoder 10 of FIG. 1 undertakes WP using the implicit mode and the explicit mode, respectively. Next, steps 360 and 370 both occur during which inter-prediction decoding and error concealment occur with the WP parameters obtained during steps 340 and 350, respectively. During step 380, a comparison occurs of the concealment results obtained during steps 360 and 370 with the best results selected for output during step 340. A spatial continuity measure, for example, may be employed to determine which mode yielded better concealment.

The decision to proceed with a priori mode determination in accordance with the method of FIG. 3A can be made by considering the mode of the correctly received spatially neighboring slices of the corrupted area in the current picture or that of temporal co-located slices in referenced pictures. In JVT, the same mode must be used for all slices in the same picture, but the mode can differ from the temporal neighbor (or temporal co-located slice). For error concealment, no such restriction exists, but it is preferred to use the mode of spatial neighbors if they are available. The mode of a temporal neighbor is only used if spatial neighbors are not available. This approach avoids the need to change the original WP function at decoder 10. Also, using spatial neighbors is simpler than temporal ones, as discussed hereinafter.

Another method uses the current slice coding type to dictate the decision to proceed with a priori mode determination on. For a B slice, use implicit mode. For a P slice, use explicit mode. The implicit mode only supports bipredicted macroblocks in B slices, and does not support P slices. In general, WvP parameters estimation is simpler for implicit mode than for explicit mode as discussed hereinafter.

For the a posteriori mode selection as described with respect to FIG. 3B, the decoder 10 of FIG. 1 can apply virtually any criterion used to measure the quality of error concealment without using the knowledge of original data. For example, the decoder 10 could compute both WP modes and retain the one producing the smoothest transitions between the borders of concealed block and its neighbors.

The following criterion is utilized to make a mode decision on a case-by-case basis when WP can improve the performance of error concealment even when WP is not used in the current or neighboring pictures. In a first case, we can use WPT implicit mode to weight bi-predictive compensation with unequal temporal distance. Without loss in generality, it can always be assumed that the picture is more correlated with the nearer neighboring picture and the simplest way to model such correlation is to use linear model, which conforms to the WP implicit mode, where WP) parameters are estimated based on the relative temporal distance between the current picture and reference pictures as Equation (4). In accordance with a preferred embodiment of the. present principles, temporal error concealment occurs using the WP implicit mode when using bi-predictive compensation. Using the WP) implicit mode affords the advantage of improving the concealed image quality for fade/dissolve sequences without needing to detect the scene transition.

In the second case, we can use WP explicit mode to weight bi-predictive compensation considering the picture/slice types. For a coded video stream, the coding quality can differ from one picture/slice type to another. In general, I-pictures have a higher coded quality than the other types and P or B_stored is higher than B_disposable. In temporal error concealment for bi-predictivevly coded blocks, if VIP is used and the weighting takes the picture/slice type into consideration, the concealed image can have higher quality. In accordance with the present principles, bi-predictive temporal error concealment makes use of the explicit mode when applying WP parameters according to the picture/slice coding type.

In the third case, we can use the WP explicit mode to limit error propagation when a concealed image is used as a reference. In general, a concealed image constitutes an approximation of the original and the quality can become unstable. Using a concealed image as a reference for future pictures can propagate errors. In temporal concealment, applying less weighting for a concealed reference picture itself limits the error propagation. In accordance with the present principles, applying the WP explicit mode for bi-predictive temporal error concealment serves to limit error propagation.

We can also use WP for error concealment upon detecting a fade/dissolve. WP has particular usefulness for coding fading/dissolve sequences, and thus can also improve the quality of error concealment for those sequences. Thus, in accordance with the present principles, WP should be used when fade/dissolve is detected. For this purpose, the decoder 10 will include a fade/dissolve detector (not shown). As for the decision to select the implicit or explicit mode, either an a priori or a posteriori criteria can be used. For an a priori decision, adoption of the implicit mode occurs upon the use of bi-prediction. Conversely, adoption of the explicit mode occurs upon the use of uni-prediction. For the posteriori criteria, the decoder 10 can apply any criteria used to measure the quality of error concealment without using the knowledge of original data. For the implicit mode, the decoder 10 derives the WP parameters based on the temporal distance, using equation 4. But for explicit mode, the WP parameters used in equations (1)-(3) need to be determined.

### WP Explicit Mode Parameter Estimation

If WP is used in the current picture or neighboring pictures, the WP parameters can be estimated from spatial neighbors if they are available (i.e., if they are received without transmission errors), or from temporal neighbors, or by making use of both. If both upper and lower neighboring pictures are available, the WP parameters are the average of two, both for weighted factors and offsets. If only one neighbor is available, the WP parameters are the same as those of the available neighbor.

An estimate for WP parameter from temporal neighbors can be obtained by setting the offsets to 0, and writing weighted prediction for uni-prediction as

SampleP=Sample P0·w₀, (6)

and for bi-prediction

SampleP=(SampleP0·w₀+SampleP1·w₁)/2, (7)

where wᵢ is weighted factor.

The current picture is denoted as f, the reference picture from list 0 as f₀, the reference picture from list 1 as f₁, the weighted factor can be estimated as follows:

wᵢ=avg(ƒ)/avg(ƒᵢ),i=0,1. (8)

where avg is the average intensity(or color component) value (denoted by avg) of the entire picture. Alternatively, Equation (8) need not use the entire picture but just the co-located region of corrupted area in the avg( ) calculation.

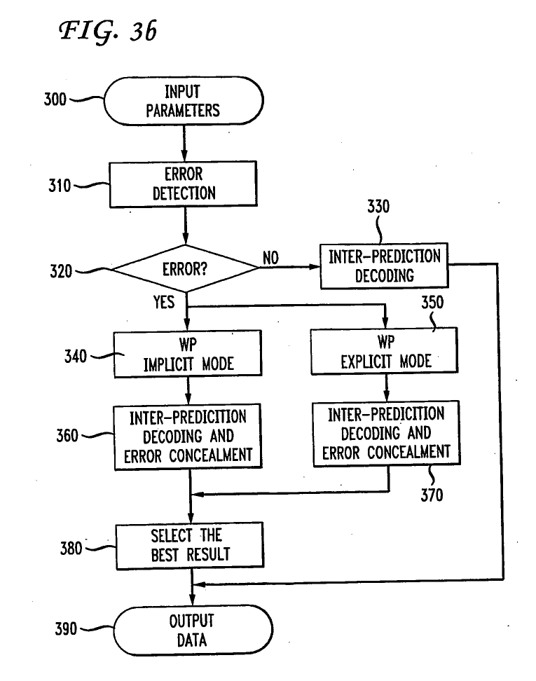

In equation (8), because some regions in the current picture f are corrupted, an estimate of avg(f) becomes necessary to calculate the weighting factor. Two approaches exist. A first approach uses curve fitting to find the value of avg(f) as depicted in FIG. 4. The abscissa measures time, while the ordinate measures the average intensity(or color component) value (denoted by avg) of the entire picture, or that of the co-located region of the corrupted area of the current picture.

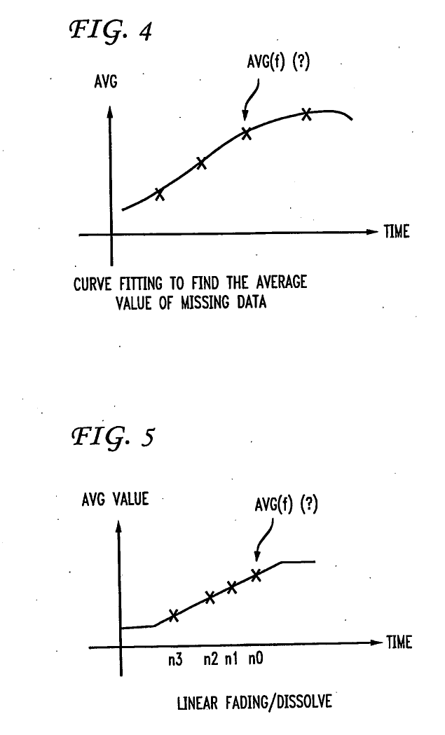

A second approach assumes that current picture experiences a gradual transition of a linear fading/dissolve, as shown in FIG. 5. Mathematically, this condition can be expressed as:

$$\frac{avg ( f ) - avg ( {f}_{0 , 1} )}{{n}_{0} - {n}_{1}} = \frac{avg ( {f}_{n 2} ) - avg ( {f}_{n 3} )}{{n}_{2} - {n}_{3}} \qquad ( 9 )$$

where the subscript is the time instant, n0 is for current picture, n1 is for the reference picture, n2, n3 are previous decoded picture before or equal to n1, and n₂≠n₃. Equation (9) enables calculation of avg(f). Equation (8) enables calculation of the estimated weighted factor. If the actual fading/dissolve is not linear, using different n2, n3 will give rise to a different w. A slightly little more complicated method would involve testing several choices for n2 and n3, then finding the average of w of all choices.

Using a priori criterion to select VWP parameters. from spatial neighbors or temporal neighbors, spatial neighbors have high priority. Temporal estimation is only used if spatial neighbor is not available. This assumes that fades/dissolves are uniformly applied across the entire picture and the complexity for calculating WP parameters using spatial neighbors is lower than that using temporal ones. For the a posteriori criteria, the decoder 10 can apply any criteria used to measure the quality of error concealment without using the knowledge of original data.

If WV) is not used for encoding the current or neighbor picture, we can estimate WP parameters by other methods. Where the WP explicit mode is used by adjusting weighted bi-predictive compensation in consideration of the picture/slice types, the WP offsets are set to 0 and the weighting factors are decided based on the slice type of temporal co-located block in the list 0 and list 1 reference pictures. If they are same, then set w₀=w₁. If they are different, the weighting factor which has slice type I is larger than that of P, the weighting factor of P is larger than that of B_stored, and the weighting factor of B-stored is larger than that of B_disposable. For example, if the temporal co-located slice in list 0 is I, and that in list 1 is P, then w₀>w₁. A condition needs to be met while deciding the weighted factor; in equation (7), (w₀+w₁)/2=1.

Where the WP explicit mode is used to limit error propagation when a concealed image is used as, the following examples illustrates how to calculate the weighting based on the error-concealed distance of predicted block and it's nearest precedence who have an errors. The error-concealed distance is defined as the iterative numbers of motion compensation from current block to its nearest precedence who has an error. For example, if image block fₙ (the subscript n is the temporal index) is predicted from fₙ₋₂, fₙ₋₂ is predicted from fₙ₋₅ and fₙ₋₅ is concealed, the error-concealed distance becomes 2.

For simplicity, WP offsets are set to 0 and weighted prediction are written as

SampleP=(SampleP0·W₀+SampleP1·W₁)/(W₀+W₁).

We define

W₀=1−αⁿ⁰ and W₁=1−βⁿ¹

where 0≦α,β≦1, n0,n1 are the error-concealed distance of SampleP0 and SampleP1. A table lookup can be used to keep track of error-concealed distance. When an intra block/picture is met, the error-concealed distance is considered to be infinite.

When a picture/slice is detected as a fade/dissolve for the explicit mode, because WP is not used for current picture, no spatial information is available. In this situation, Equations (6)-(9) allow deriving the WP parameters from temporal neighbors.

The foregoing describes a technique for concealing errors in a coded image formed of an array of macroblocks using weighted prediction.

1-32. (canceled)

33. A method of concealing spatial errors during decoding of an image comprised of a stream of macroblocks coded using weighted prediction, comprising the steps of:
examining at least one macroblock for pixel data errors during weighted prediction decoding, and if any such errors exist, then:
weighting the at least one macroblock in accordance with the weighted prediction decoding with at least one reference picture to yield a weighted prediction for concealing a macroblock found to have pixel errors.

34. The method according to claim 33 further comprising the steps of:
selecting an implicit weighted prediction decoding mode; and
weighting at least one macroblock using implicit mode weighted prediction.

35. The method according to claim 33 further comprising the steps of:
selecting an explicit weighted prediction decoding mode; and
weighting at least one macroblock using explicit mode weighted prediction.

36. The method according to claim 34 further comprising the step of using the implicit mode for temporal concealment with use of bi-predictive compensation.

37. The method according to claim 33 further comprising the step of weighting at least one macroblock using bi-predictive compensation in accordance with a type a type of reference picture.

38. The method according to claim 37 further comprising the step of weighting at least one macroblock to limit error propagation when at least a portion of at least one reference picture was previously concealed.

39. The method according to claim 37 further comprising the step of weighting at least one macroblock to limit error propagation when at least a portion of the at least one reference picture was iteratively concealed.

40. The method according to claim 37 further comprising the step of weighting each of at least two different macroblocks from different reference pictures to yield a weighted prediction for concealing a macroblock found to have pixel errors.

41. The method according to claim 37 further comprising the weighting the at least one macroblock of a current picture and a neighboring picture.

42. The method according to claim 33 further comprising the step of weighting the at least one macroblock when one of a fading or dissolve is detected.

43. The method according to claim 33 further comprising the step of weighting the at least one macroblock using one of an implicit and explicit mode in accordance with prescribed criterion.

44. The method according to claim 43 further comprising the step of weighting the at least one macroblock using one of an implicit and explicit mode in accordance with criterion associated with one of a spatial and temporal neighboring macroblock, respectively.

45. The method according to claim 44 further comprising the step of weighting the at least one macroblock using one of an implicit and explicit mode in accordance with criterion associated with one of a spatial and temporal neighboring macroblock, respectively, that are correctly received.

46. The method according to claim 43 further comprising the step of weighting at the least one macroblock using one of an implicit and explicit mode in accordance with criterion associated the reference picture type.

47. The method according to claim 35 further comprising the step of estimating a weighting value for weighting the at least one macroblock from a temporal neighboring macroblock.

48. The method according to claim 47 further comprising the step of estimating the weighting value from the temporal neighboring macroblock by curve fitting to find an average intensity value from which such estimated weighting value is derived.

49. The method according to claim 47 further comprising the step of estimating the weighting value from a temporal neighboring macroblock based on a linear fading/dissolve in the reference picture.

50. The method according to claim 39 further comprising the step of estimating a weighting value for weighting the at least one macroblock from at least one spatial neighboring macroblock.

51. The method according to claim 41 further comprising the step of estimating weighting value for weighting the at least one different macroblock from at least one of a spatial and temporal neighboring macroblock in accordance with prescribed criterion.

52. The method according to claim 41 wherein the prescribed criterion includes assigning the at least one spatial neighboring macroblock a higher priority.

53. The method according to claim 37 further comprising the step of selecting the reference picture from a collection of recently stored pictures.

54. A method of concealing, spatial errors in an image comprised of a stream of macroblocks coded using weighted prediction, comprising the steps of:
examining each macroblock for pixel data errors, and if such errors exist during weighted mode decoding, then:
weighting, each of at least two different macroblocks from at least two different reference pictures by an amount determined by the weighted prediction decoding to yield a weighted prediction for concealing a macroblock found to have pixel errors.

55. A decoder for concealing spatial errors during decoding of an image comprised of a stream of macroblocks coded using weighted prediction, comprising
a detector for examining each macroblock for pixel data errors; and
an error concealment parameter generator for generating values for weighting at least one macroblock from a reference picture using one of a first and second weighting modes in accordance with the decoding of the macroblocks for concealing a macroblock found to have pixel errors.

56. The decoder according to claim 55 wherein the detector comprises a variable length decoder block.

57. The decoder according to claim 55 wherein the error concealment parameter generator generates values for weighting the at least one macroblock to limit error propagation when at least a portion of the reference picture was previously concealed.

58. The decoder according to claim 55 wherein the error concealment parameter generator generates values for weighting the at least one macroblock when one of a fading or dissolve is detected.

59. The decoder according to claim 55 wherein the error concealment parameter generator generates values for weighting the at least one macroblock using one of the implicit and explicit mode in accordance with prescribed criterion.

60. The decoder according to claim 59 wherein the error concealment parameter generator generates values for weighting the at least one macroblock in accordance with criterion associated with one of a spatial and temporal neighboring macroblock.
